(19) United States
(12) Patent Application Publication
(10) Pub. No.: US 2026/0252458 A1
(43) Pub. Date: Aug. 27, 2026

(54) COMPREHENSIVE INFORMATION TECHNOLOGY LANDSCAPE MONITORING AND ANALYSIS SYSTEM

(71) Applicant: Morgan Stanley Services Group Inc., New York, NY (US)

(72) Inventors: Amit Kumar Tiwari, Mumbai (IN); Anand Singh, Mumbai (IN); Mohan Gowda, Mumbai (IN); Anurag Muley, Mumbai (IN); Stephen Gregory, Jersey City, NJ (US)

(21) Appl. No.: 19/065,492

(22) Filed: Feb. 27, 2025

(51) Int. Cl. G06F 11/32; G06F 11/30

(52) U.S. Cl. CPC G06F 11/327; G06F 11/3051

(57) ABSTRACT

Systems and methods for implementing a comprehensive information technology (IT) landscape analysis tool are provided. The analysis tool provides multiple layers of analytics including: monitoring gap analysis, alert configuration analysis and false positive alerts analysis. An embodiment of the present invention automates monitoring gap identification, enforces alert configuration standards, and distinguishes true from false positives. This information may be used to improve monitoring coverage, reduce the number of false positive alerts and improve the efficiency and effectiveness of IT monitoring and technology. Through interactive user interfaces, an embodiment of the present invention enables and empowers organizations to implement optimized monitoring strategies, enhance IT reliability, proactively address issues and provide actionable insights for leadership, managers, engineers and technology specialists.

### FIELD OF THE INVENTION

The present invention relates generally to implementing a monitoring system that provides a comprehensive information technology landscape through a combination of a monitoring gap analyzer, a compliance/standard analyzer and a false positive analyzer.

### BACKGROUND

The current landscape of IT monitoring and alerting is generally characterized by an extensive use of many different monitoring tools within large organizations. This conventional multi-tool approach is necessitated by the diverse nature of IT environments, which includes a wide array of components such as applications, databases, middleware, URLs, hosts, share drives and jobs. Each monitoring tool often focuses on a specific facet of monitoring but lacks any ability to provide comprehensive information.

This piecemeal approach results in an incomplete understanding of an organization's IT landscape, leaving critical IT components unmonitored and vulnerable. More specifically, available systems experience alert configuration divergence and inconsistent alert configurations across the organization leading to inefficiencies, missed incidents, and increased operational risks. Inconsistent alerting means that alert configurations are varied across teams, resulting in confusion and inaccurate information. Because organizations are concerned about potential attacks, most current solutions are overly inclusive and therefore lack an ability to identify false positives. A high rate of false positives alerts generate unnecessary work for IT teams and further reduce the effectiveness of monitoring systems.

Accordingly, there is a need for an improved system and method for an intelligent monitoring system that provides a comprehensive multi-layered solution to address challenges of IT monitoring within a large, diverse organization.

### SUMMARY

Systems and methods for addressing the complex technical challenges of managing monitoring gaps, alert standardization, and false positive alerts across various diverse monitoring tools and technologies are described. An embodiment of the present invention provides a unique combination of analysis and technical insights, including automated gap identification, alert standardization validation, and false positive analysis, thereby providing a distinct solution tailored to organizations grappling with intricate IT infrastructure.

According to an embodiment, a computer-implemented system comprises: computer server comprising one or more processors; a centralized database storing monitoring data; and non-transitory memory comprising instructions that, when executed by the one or more processors, cause the one or more processors to: extract, via a monitoring tool data extractor, monitoring data from a plurality of disparate monitoring tools deployed within an entity; extract, via a database extractor, configuration data from a plurality of disparate configuration management databases residing within the entity; extract, via an alert data extractor, alert data from a plurality of disparate aggregation tools deployed within the entity; normalize, via a normalization engine, the extracted monitoring data, the extracted configuration data and the extracted alert data into a common data format; store, via the centralized database, normalized extracted data in the common data format, wherein the centralized database is communicatively coupled to a monitoring standards repository and a metadata repository; analyze, via a monitoring gap analyzer, the normalized extracted data to identify one or more monitoring gaps within the plurality of disparate monitoring tools; analyze, via a monitoring standard analyzer, the normalized extracted data to identify one or more instances of non-compliance based on a set of monitoring standards and the extracted configuration data; analyze, via a false positive alert identifier, the normalized extracted data to identify one or more false positive alerts associated with the plurality of disparate monitoring tools based on the extracted alert data, wherein the one or more false positive alerts are determined with respect to a predetermined threshold; generate, via the processor, a monitoring coverage metric that represents the one or more monitoring gaps, an alert-compliance metric that represents one or more instances of non-compliance and a false positive metric that represents the one or more false positive alerts, wherein the monitoring coverage metric, the alert-compliance metric and the false positive metric represents a comprehensive IT landscape associated with the entity; and transmit, via a communication network, the monitoring coverage metric, the alert-compliance metric and the false positive metric to an interactive user interface.

According to another embodiment, a computer-implemented method comprises the steps of: extracting, via a monitoring tool data extractor, monitoring data from a plurality of disparate monitoring tools deployed within an entity; extracting, via a database extractor, configuration data from a plurality of disparate configuration management databases residing within the entity; extracting, via an alert data extractor, alert data from a plurality of disparate aggregation tools deployed within the entity; normalizing, via a normalization engine, the extracted monitoring data, the extracted configuration data and the extracted alert data into a common data format; storing, via the centralized database, normalized extracted data in the common data format, wherein the centralized database is communicatively coupled to a monitoring standards repository and a metadata repository; analyzing, via a monitoring gap analyzer, the normalized extracted data to identify one or more monitoring gaps within the plurality of disparate monitoring tools; analyzing, via a monitoring standard analyzer, the normalized extracted data to identify one or more instances of non-compliance based on a set of monitoring standards and the extracted configuration data; analyzing, via a false positive alert identifier, the normalized extracted data to identify one or more false positive alerts associated with the plurality of disparate monitoring tools based on the extracted alert data, wherein the one or more false positive alerts are determined with respect to a predetermined threshold; generating, via the processor, a monitoring coverage metric that represents the one or more monitoring gaps, an alert-compliance metric that represents one or more instances of non-compliance and a false positive metric that represents the one or more false positive alerts, wherein the monitoring coverage metric, the alert-compliance metric and the false positive metric represents a comprehensive IT landscape associated with the entity; and transmitting, via a communication network, the monitoring coverage metric, the alert-compliance metric and the false positive metric to an interactive user interface.

These and other advantages will be described more fully in the following detailed description.

### BRIEF DESCRIPTION OF THE DRAWINGS

In order to facilitate a fuller understanding of the invention, reference is made to the attached drawings. The drawings should not be construed as limiting the invention, but are intended only to illustrate different aspects and embodiments of the invention.

FIG. 1 is an exemplary system architecture, according to an embodiment of the present invention.

FIG. 2 is an exemplary user interface, according to an embodiment of the present invention.

FIG. 3 is an exemplary user interface, according to an embodiment of the present invention.

FIG. 4 is an exemplary user interface, according to an embodiment of the present invention.

FIG. 5 is an exemplary user interface, according to an embodiment of the present invention.

FIG. 6 is an exemplary user interface, according to an embodiment of the present invention.

FIG. 7 is an exemplary user interface, according to an embodiment of the present invention.

FIG. 8 is an exemplary user interface, according to an embodiment of the present invention.

### DETAILED DESCRIPTION

Exemplary embodiments of the invention will be described in order to illustrate various features of the invention. The embodiments described herein are not intended to be limiting as to the scope of the invention, but rather are intended to provide examples of the components, use, and operation of the invention.

An embodiment of the present invention is directed to a comprehensive information technology (IT) landscape analysis tool. The analysis tool provides multiple layers of analytics including: monitoring gap analysis, alert configuration analysis and false positive alerts analysis. An embodiment of the present invention automates monitoring gap identification, enforces alert configuration standards, and distinguishes true from false positives. This information may be used to improve monitoring coverage, reduce the number of false positive alerts and improve the efficiency and effectiveness of IT monitoring and technology. Through interactive user interfaces, an embodiment of the present invention enables and empowers organizations to implement optimized monitoring strategies, enhance IT reliability, proactively address issues and provide actionable insights for leadership, managers, engineers and technology specialists.

An embodiment of the present invention is directed to an innovative combination of analyzers that include: Monitoring Gap Analyzer, Monitoring Standard Analyzer and False Positive Analyzer to comprehensively and accurately address technology issues and risks across an IT landscape for large organizations and businesses.

Monitoring Gap Analyzer collects data from various IT resources, normalizes the data, and then reconciles the data with existing monitoring tool data. Monitoring Gap Analyzer provides a complete and comprehensive IT landscape and also identifies gaps in monitoring coverage and exceptions. The data may then be presented through high-level and detailed level interfaces. With an embodiment of the present invention, various technical benefits including holistic observability and risk mitigation may be realized. An embodiment of the present invention may comprehensively cover the IT landscape within a business unit, offering insight into observability coverage. In addition, unmonitored components may be identified, enabling targeted monitoring efforts. By proactively addressing monitoring issues, an embodiment of the present invention aims to reduce risk, minimize downtime and protect an entity's reputation. For example, an embodiment of the present invention may identify that an organization with a total of 800 components has a gap of 200 components that are not being monitored or not monitored properly.

Monitoring Standard Analyzer compares existing alert configurations with organizational standards. Monitoring Standard Analyzer identifies alerts that do not conform to these standards and provides detailed guidance and information for remediation. An embodiment of the present invention may verify adherence to standards and further ensure alert configurations follow organization-wide guidelines for metrics and severity levels. According to the example, while 600 components are being monitored, a subset of those components may not be monitored properly in a manner that abides by a set of relevant standards. An embodiment of the present invention may provide a recommendation for standard compliance as well as automatic adjustment to a standard level that is acceptable. Other variations may be realized.

False Positive Analyzer analyzes alerts generated by configured alert rules across multiple monitoring tools. False Positive Analyzer marks alerts as true or false based on incident ticket analysis or other feedback and then calculates the percentage of true positives for each alert rule. Following the example of the 600 components, there may be another subset of components that produce false positives above a threshold for a set of performance metrics. For example, a particular server may be determined to produce 90% false positives. An embodiment of the present invention may enhance alert precision through a robust algorithm that categorizes alerts into false and true positives by analyzing incident tickets and component logs. This minimizes false alerts, reduces alert fatigue, and enhances the effectiveness of the alert system. Accordingly, site reliability engineers (SREs) or other users may focus on genuine issues, contributing to increased application reliability crucial in various sectors.

An embodiment of the present invention is directed to a structured process to systematically identify and address false positive alerts. This process ensures that each alert undergoes validation before it is closed, thereby improving operational efficiency and reducing noise in the system by identifying which resources are generating false positive alerts.

Whenever an alert is triggered, the alert may be classified as: False Positive (an alert that does not indicate a real issue) or True Positive (a genuine alert that requires investigation). For example, to enforce this, a dropdown selection may be implemented within an alerting console to prevent users from closing an alert without explicitly categorizing it. This ensures that every alert is properly evaluated and enables improved tracking of false positives.

In addition, an embodiment of the present invention may implement an integrated Robotic Process Automation (RPA) into an alert-handling workflow. For example, when an alert is triggered, the RPA system may perform an initial diagnostic assessment to determine whether the alert is likely a false positive. If the RPA engine identifies the alert as a false positive, it may automatically update the alert console as a false positive. Benefits may include an ability to track and analyze which resources are generating frequent false positives. By capturing this data, an embodiment of the present invention may: identify misconfigured monitoring rules or ineffective thresholds; optimize monitoring configurations to reduce noise; improve alerting precision by refining alert logic and suppression mechanisms; and provide actionable insights to teams responsible for resource management and monitoring improvements.

This structured approach-user-driven classification, RPA-assisted diagnosis, and resource tracking-ensures: Reduced Alert Fatigue by minimizing unnecessary alerts by identifying and addressing frequent false positives; Standardized Alert Handling by enforcing a structured process to ensure every alert is reviewed before closure; Enhanced Automation by leveraging RPA to handle initial diagnostics, reducing the manual workload for support teams; and Continuous Monitoring Optimization by enabling data-driven improvements to monitoring.

An organization may receive hundreds of thousands of alerts during a short time period, e.g., days, weeks, months, with only a small team or limited resources to address each alert. An embodiment of the present invention is directed to narrowing the universe of alerts in a manner that accurately represents technical issues that need to be addressed. This may involve removing duplicative alerts, related alerts as well as symptomatic alerts. For example, a server may experience an issue and generate an alert. In this instance, one or more other monitoring tools may raise alerts stemming from the same server issue. Because an organization utilizes many different monitoring tools, oftentimes the same alert is raised multiple times. An embodiment of the present invention may identify unique characteristics of an alert and eliminate alerts that stem from the same incident.

In another example, an embodiment of the present invention may be directed to identifying an original alert and removing symptomatic alerts. For example, a server may host 20 applications. The server may experience an alert situation resulting in all 20 applications behaving abnormally. Each of these 20 applications may be monitored by a different monitoring tool that then generates individual alerts for each of the 20 applications in addition to the server alert. An embodiment of the present invention may recognize that the server alert is the original alert and remove or obscure the related alerts. This enables a user to address the server alert rather than use resources on addressing the applications individually.

An embodiment of the present invention may identify a false positive configuration that has caused false positive alerts and assist in removing or modifying the alert configuration.

An embodiment of the present invention provides efficient automation and proactive issues resolution. Automation, coupled with light weight backend scripts, align with SRE principles with proactive identification of gaps, and further ensures a resilient operational environment.

An embodiment of the present invention solves a technical problem by using a variety of data sources to generate interfaces and outputs that identify monitoring gaps, alert configuration issues, and false positive alerts. This information may be used to improve monitoring coverage, reduce the number of false positive alerts, and improve the efficiency and effectiveness of IT monitoring. By enforcing standards and identifying false positives, an embodiment of the present invention reduces alert noise and enhances the effectiveness of alert management.

An embodiment of the present invention also improves the operation of a computer system or computer technology by providing a comprehensive view of an organization's IT landscape, which can help organizations to identify and address potential problems before they cause outages or other disruptions.

An embodiment of the present invention provides comprehensive automation, visualization, reconciliation, standardization and false positive analysis. The entire monitoring process may be automated and optimized from data collection and normalization to reconciliation, alert configuration validation, and false positive analysis. Interactive user interfaces may provide high-level summaries and detailed insights, allowing a range of users to take appropriate and actionable steps. Configuration Management Database (CMDB) data may be reconciled with monitoring tool data, ensuring accurate and up-to-date information for monitoring coverage analysis. Monitoring alert configuration standards may be enforced thereby ensuring that alerts are consistent with organizational guidelines. False Positive Analysis involves distinguishing between true and false positive alerts, helping organizations fine-tune alert rules and reduce alert fatigue.

CMDB may represent a central repository that stores and manages information relating to components (e.g., hardware, software, network elements, etc.) within an IT infrastructure. In addition, CMDB may also store and manage attributes, relationships, dependencies and other data relating to the components. CMDB may be used to manage and track changes across an entire IT environment.

An embodiment of the present invention may store monitoring data gaps, alert standard gaps and false positive configuration data in a database is stored on our database.

Technical benefits may include: comprehensive monitoring that ensures complete monitoring coverage, reducing the risk of critical IT incidents; efficiency through automation of monitoring tasks, saving time and resources; standardization by enforcing alert configuration standards, improving consistency and effectiveness and alert accuracy may be achieved by accurately distinguishing between true and false positive alerts, reducing alert fatigue.

An embodiment of the present invention may support a wide range of use cases, applications, etc. For Enterprises, large organizations may proactively manage their IT infrastructure, reduce risks, and improve operational efficiency. For IT Service Providers, companies offering IT services may enhance their monitoring capabilities and offer more reliable services to clients. For Software Vendors, monitoring tool vendors may provide a comprehensive monitoring and alerting platform. For Data Centers, operators may ensure the availability and performance of hosted systems. For Regulated Industries, organizations (e.g., finance, healthcare) may maintain compliance with monitoring standards and regulations.

According to an illustrative application, an embodiment of the present invention may be implemented within a business unit to address specific monitoring challenges. As part of an ongoing IT infrastructure transformation, some applications may have been migrated to a private cloud environment. During this migration process, the Monitoring Gap Analyzer may be deployed to access and report on the monitoring coverage of these applications. This provides an ability to enhance a monitoring practice for migrated applications.

According to another application, a business unit may be in the midst of a substantial IT migration initiative, which includes a significant swift towards cloud-based infrastructure. The business unit may be planning to migrate a substantial portion of existing applications from on-premise to cloud environments. At this stage, an embodiment of the present invention may be extensively employed as a framework and governance tool to ensure that monitoring is in place from the beginning and throughout the migration process. An embodiment of the present invention may be used to maintain the integrity, reliability, and performance of IT systems during and after the migration.

Accordingly, an embodiment of the present invention may represent an integral part of a strategy to streamline and optimize IT monitoring practices in alignment with an evolving IT landscape.

An embodiment of the present invention provides a comprehensive monitoring solution designed to provide in-depth insights into the performance and compliance of a business unit's IT systems.

In response to the evolving landscape within technology business units, characterized by the adoption of modern platforms and tools like public cloud, private cloud, micro-service architecture, and container orchestration tools, complexity has significantly heightened. Consequently, traditional monitoring tools and methods are no longer relevant. Accordingly, an embodiment of the present invention is directed to addressing vulnerabilities and enhancing observability coverage with a forward-thinking approach.

In addition, an embodiment of the present invention may be applicable in acquisitions/mergers where standardization in observability practices is relevant. An embodiment of the present invention enables the scanning of existing observability infrastructure in an acquisition target, aligning it with an acquiring entity's standards. For one online application, an entity may have 30 different development teams that apply different standards based on business and technical objectives. An embodiment of the present invention may identify a set of metrics to monitor for compliance for each facet (e.g., applications, databases, servers, hosts, etc.) across the development teams. This ensures a comprehensive understanding of the observability state in the acquisition target's system and also establishes a standardized observability governance across an entire entity.

Generally, an acquiring entity and target entity may use very different technology, software and overall infrastructure which makes providing a comprehensive IT landscape extremely difficult and highly complex. For example, a single application may involve hundreds and hundreds of components. Any product or service offering may involve multiple applications involving an enormous number of components and metrics to identify and properly analyze. Typically, a entity may use a wide range of many different components, e.g., thousands and thousands of servers, load balancers, databases, networks, and other IT components. Within each category of components, there may be many different types and variations used throughout a entity.

In the context of an acquisition or merger, there may be a significant divergence in technology components as well as monitoring standards and metrics between the entity and the target entity. For example, the target entity may have a different business and use technology that is much older or outdated. An embodiment of the present invention may be applied in this situation to accurately identify and organize technical components and then determine a suite of monitoring tools to be applied during an integration, migration, acquisition or merger.

An embodiment of the present invention may support various implementations including a plug-and-play solution. Designed with adaptability in mind and leveraging its plug-and-play nature, an embodiment of the present invention integrates with existing systems, providing a portable and ready-to-use solution.

Various users, including SREs, may be empowered with Continuous Improvement by identifying observability gaps, standardize alerts, and enhance operational excellence within IT teams, fostering a culture of continuous improvement.

An embodiment of the present invention is directed to an automatic adjustment feature. In response to a false positive alert, an embodiment of the present invention may make an adjustment to a threshold or other metric to bring the component into alignment or compliance with relevant standards. Other variations may be implemented.

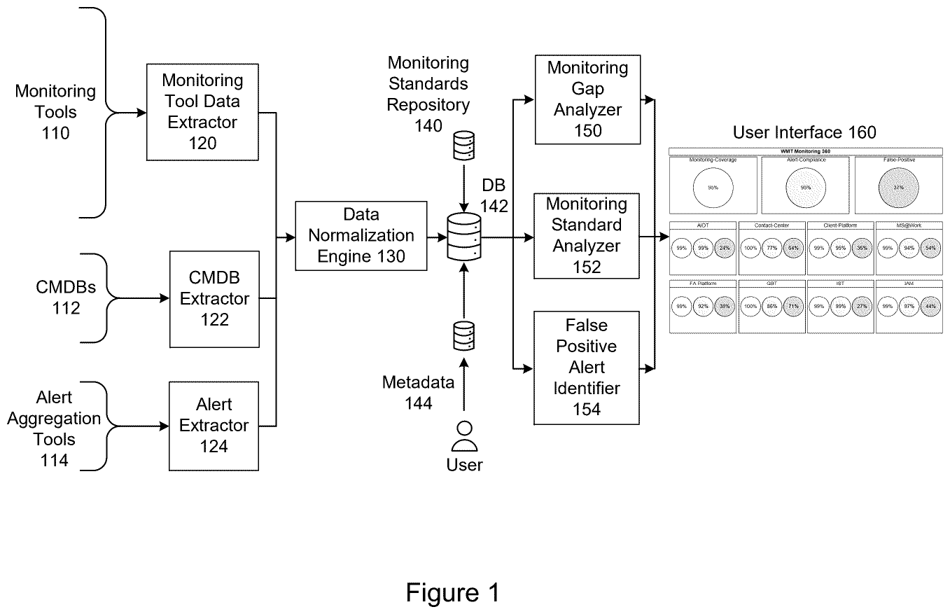

FIG. 1 is an exemplary architecture system diagram, according to an embodiment of the present invention. An embodiment of the present invention addresses a critical technical need for comprehensive IT landscape monitoring with a multi-layered approach that reveals live coverage of observability, ensuring adherence to organizational standards, while identifying opportunities to improve alert efficiency and reduce false positives.

An embodiment of the present invention extracts data from various sources, as shown by Monitoring Data Tool Extractor 120, CMDB Extractor 122 and Alert Extractor 124.

Monitoring Data Tool Extractor 120 may extract data relating to various monitoring tools 110 including observatory tools, custom tools, vendor tools, etc. Monitoring Tools 110 may be distributed across various divisions, locations, units, etc. An entity may use a wide range of monitoring tools for each component, category of components, business units, etc. As a result, an organization may use an assortment of monitoring tools including vendor tools, custom tools, etc. Each monitoring tool may be used in isolation and without regard for other similar tools or tools within a business unit. Accordingly, an entity may utilize a diverse range of disjointed monitoring tools to observe only portions of a business wherein each monitoring tool operates for a specific view in isolation. With current system configurations, it is not possible to gain comprehensive insight into an entity's IT landscape.

CMDB Extractor 122 may extract data that represents information from thousands and thousands of components including hosts, servers, load balancers, databases and other IT components. This data may be managed in various CMDBs 112 across an organization. As many components and monitoring tools operate in isolation, there is no common standard that is applied across an organization. Without a common standard, it is not possible to monitor an organization in a comprehensive manner. Common standards may be applied to each type of component as well as across multiple classes of components. For example, an organization may need a standard for each type of component, including hosts, applications, etc.

Alert Extractor 124 may extract data from Alert Aggregation Tools 114 that may represent various alerting tools including data relating to the actual alerts, thresholds, conditions, alert activity, metrics, etc.

An embodiment of the present invention may extract data relating to IT components at a particular phase of development. For example, the data may relate to IT components that are in production.

The extracted data may be normalized through Data Normalization Engine 130 and then stored in Database 142. The normalized data may be combined with Monitoring Standards Repository 140 and Metadata 144.

Monitoring Standard Repository 140 may serve as a central repository for maintaining monitoring standards across various facets, including message queue (MQ), hosts, URLs, applications, and databases. These standards may define the expected monitoring configurations and compliance requirements for each facet, ensuring uniformity across the environment. The Data Normalization Engine 130 may reconcile and validate resources against these established monitoring standards. It may ingest reconciliation data obtained from multiple sources including: Monitoring Tool Data Extractor 120 that provides real-time and historical monitoring information; CMDB Extractor 122 that extracts configuration and asset data from the Configuration Management Database (CMDBs 112); and Alert Extractor 124 that gathers alerts and incident-related information.

Data Normalization Engine 130 may systematically compare each resource within the reconciliation data against Monitoring Standards Repository 140 to determine compliance. It may assess whether the resources adhere to the defined WM standards and identify any deviations and/or gaps in monitoring coverage. This validation process ensures that resources conform to the required monitoring guidelines, enabling proactive issue resolution, standardized observability practices, and enhanced reliability across the infrastructure.

An embodiment of the present invention may implement three interrelated layers that collectively aim to address critical challenges in observability and alerting across an organization's IT landscape. As shown in FIG. 1, an embodiment of the present invention may integrate multiple layers of analysis, including a Monitoring Gap Analyzer 150, a Monitoring Standard Analyzer 152 and a False Positive Alert Identifier 154.

Monitoring Gap Analyzer 150 may perform observability coverage analysis by thoroughly scanning apps, hosts, databases, share drives, middle wares, URLs and jobs to pinpoint areas lacking monitoring coverage. Monitoring Gap Analyzer 150 may also seamlessly capture component details from Configuration Management Database (CMDB) to ensure a comprehensive inventory; and efficiently retrieve data from various monitoring tools in use, providing a holistic view of the monitoring landscape. In addition, Monitoring Gap Analyzer 150 may meticulously identify gaps between CMDB and monitoring tool data, flagging potential discrepancies for further investigation. Monitoring Gap Analyzer 150 also presents data in multiple informative dashboard levels including a high-level summary dashboard, as shown by 160, that visualizes the percentage of monitored components per division and highlights the tool used for each facet and a detailed dashboard that empowers users to filter by division, sub-division, or app, displaying a table with monitored status, comments, and resource names for granular insight.

Monitoring Standard Analyzer 152 may compare existing alerts to organizational standards and verify capture of standard metrics and alert severity levels. Monitoring Standard Analyzer 152 may also present data in multiple informative dashboard level: including a high-level dashboard that shows percentage of alerts requiring modification per division and a low-level dashboard that provides details of non-compliant alerts for engineer remediation, as shown by 160.

False Positive Alert Identifier 154 analyzes production alerts across various monitoring tools and further classifies alerts as “false positive” or “true positive” based on incident tickets and component logs. False Positive Alert Identifier 154 may also publish the percentage of true positives for every configured alert rule and enables teams to optimize alert rules by adjusting thresholds and metrics, as shown by 160.

This multi-layered approach empowers business units to achieve comprehensive monitoring coverage, adhere to standards, and optimize alert efficiency, ultimately leading to a more robust and proactive IT environment.

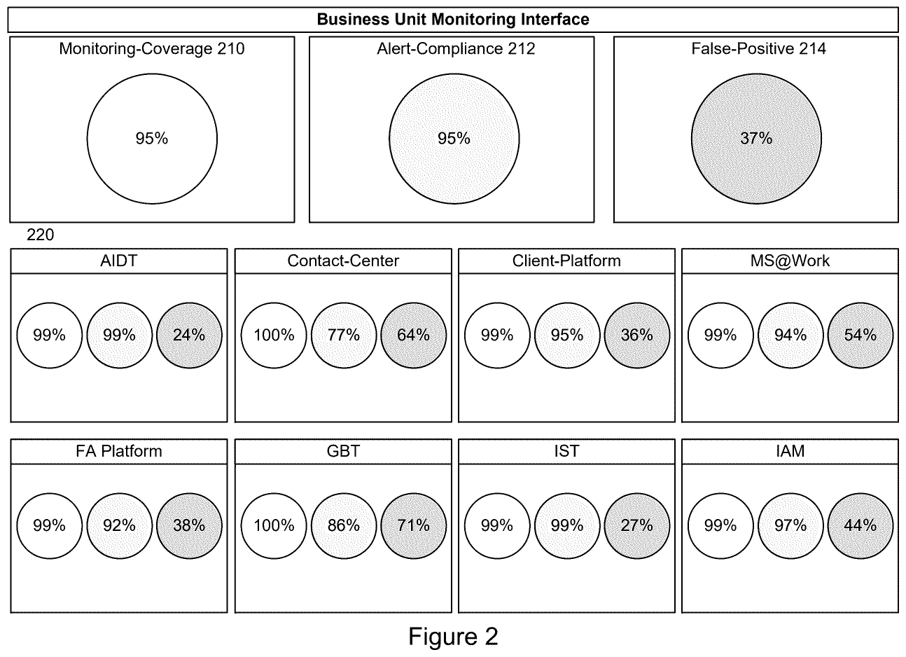

FIG. 2 is an exemplary user interface, according to an embodiment of the present invention. FIG. 2 illustrates an exemplary interface that provides division and department level overview and insights into monitoring activities. Users may access this interface to gain a high-level understanding of the state of monitoring within the organization. As shown in FIG. 2, an embodiment of the present invention may provide analysis relating to Monitoring Coverage 210, Alert-Compliance 212 and False-Positive 214.

Monitoring Coverage 210 may leverage an Observability Coverage Analyzer and/or Observability Gap Scanner that focuses on monitoring coverage and identifying any gaps in monitoring activities. Monitoring Coverage 210 may highlight the percentage of components currently being monitored and points out specific areas where monitoring may be lacking. For example, Monitoring Coverage 210 may display 95%, indicating that 95% of the total components of a team are actively monitored, while the remaining 5% represent a monitoring gap that requires attention. An embodiment of the present invention may provide analysis and details concerning the 5% gap including specific components, services, and/or infrastructure elements that are not covered, the potential impact of these gaps, and recommendations for improving monitoring coverage. In addition, an embodiment of the present invention may leverage an Observability Coverage Scanner to conduct a systematic evaluation of monitoring completeness.

Alert-Compliance 212 may assess the compliance of configured alerts against predefined alert standards. Alert-Compliance 212 may provide a percentage of alerts that meet the established criteria. For example, Alert-Compliance 212 may display 95%, indicating that 95% of the configured alerts adhere to the organization's standards, while the remaining 5% do not. An embodiment of the present invention may provide analysis and details concerning the 5% that do not including the specific alerts that are non-compliant, the nature of their non-compliance, potential risks associated with these deviations, and recommendations for remediation. An embodiment of the present invention may leverage an Alert Compliance Engine (ACE) to systematically evaluate alerts against predefined organizational standards. This evaluation may involve: identifying and classifying configured alerts based on severity, monitoring tool, and target infrastructure or application components. Alerts may be assessed against predefined standards such as: Proper severity levels (e.g., Critical, Major); Alerts created based on RED metrics (Rate, Error and duration metrics); Presence of necessary metadata (e.g., alert description, KBA, Affected_item_GRN); Compliance Scoring & Reporting: Generating a compliance percentage and visual dashboards that highlight compliance trends, gaps. Corrective actions may be suggested and may include updating metadata, creating alerts on RED based metrics or refining alert routing.

False-Positive 214 may identify false positive alerts generated by the monitoring system. Alerts generating false positives above a defined threshold may be flagged. False-Positive 214 may display 37%, indicating that 37% of the alert configurations generate false positives beyond the threshold set at 60%. Additional details provide teams with the information needed to address these false positive alerts.

Interacting with each may direct users to specific scanners, tailored to their area of interest. For example, interacting with Monitoring Coverage 210 may navigate users to an Observability Coverage Analyzer Dashboard. Interacting with Alert-Compliance 212 may direct users to the Compliance Guardian Dashboard. Interacting with False-Positive 214 may guide users to the False Alarm Identifier Dashboard.

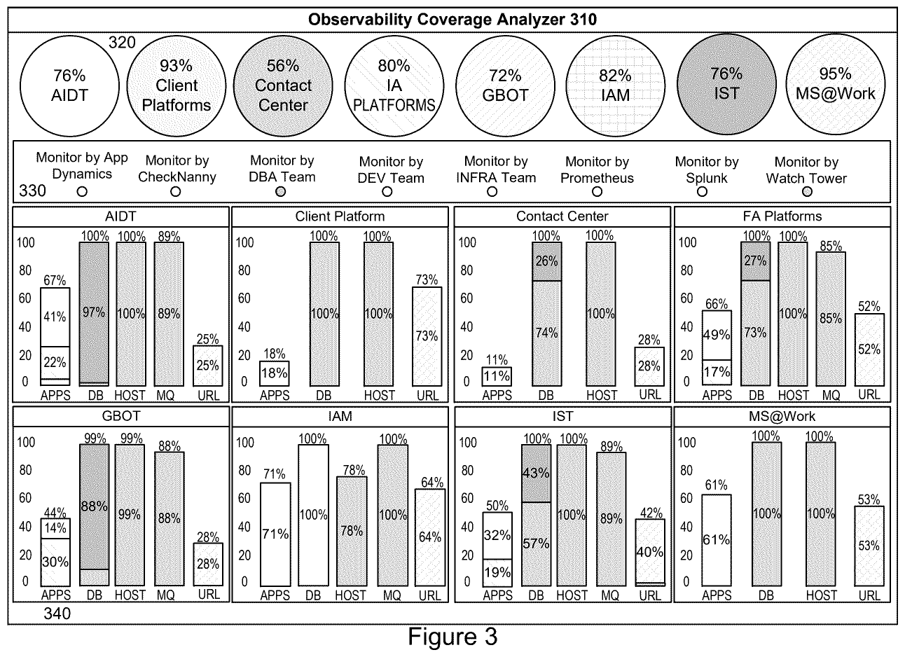

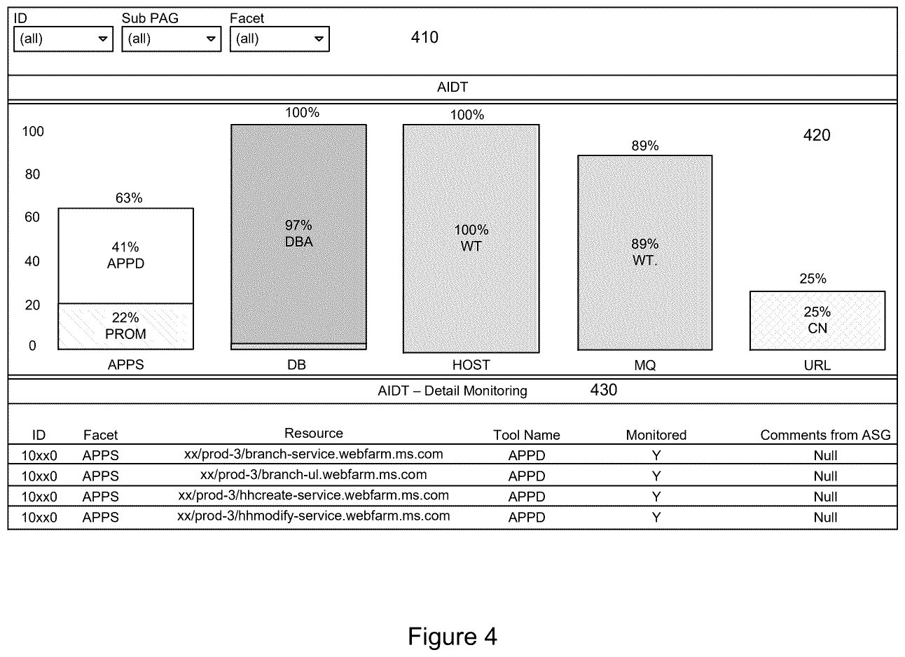

Different types of users may interact with the various interactive user interfaces in different ways. For example, senior leadership may view composite data as shown by FIG. 2. Managers or mid-level leadership may view data with team specific details, as shown by FIGS. 3, 5 and 7. Technical specialists may interact with detailed analytics to address potential issues at a more granular level, as shown by FIGS. 4, 6, and 8. According to an embodiment of the present invention, user access privileges may be implemented where appropriate to protect sensitive information.

FIG. 2 also provides PAG level insights organized in a monitoring-coverage, alert-compliance and false-positive format. PAG represent practice area group. PAG may represent other teams, units, etc. within an organization. For each PAG, an embodiment of the present invention provides observability coverage analysis, compliance analysis and false alarm analysis, as shown by Section 220. In the example of FIG. 2, PAGs may include: Analytics and Data Technology (AIDT), Contact-Center, Client-Platform, MS@Work (or other productivity software, services, hardware, platform, etc.), FA Platform, GBT, IST (Information Systems Technology) and IAM (Identity and Access Management). Other practice area groups may be supported. In this example, AIDT provides technology solutions to drive forward analytics, focused on deepening data and analytics ecosystem in partnership with the Business. Client-Platform: may provide technology solutions to service clients on various platforms. Financial Advisory (FA) Platform may represent a cloud-based platform that provides technology solutions for advisors, etc. Global Banking Technology (GBT) may provide technology solutions enabling the growth of certain businesses within a regulatory-compliant and risk-managed framework. IST may provide support to various lines of business.

Observability coverage analysis focuses on monitoring coverage within PAG. Compliance analysis evaluates alert compliance at the PAG level. False alarm analysis identifies false positive alerts generated within PAG. Interacting with each may navigate users to a respective scanner page, offering a more PAG-specific view.

FIG. 3 is an exemplary user interface, according to an embodiment of the present invention. FIG. 3 illustrates an Observability Coverage Analyzer interface 310 that provides a detailed breakdown of observability coverage, at the PAGs and facet levels. In this example, Observability Coverage Analyzer interface may include multiple sections. Facets may represent a category of IT components, such as database, load balancer, host, URLs, etc.

Top Section 320 provides an overview of observability coverage at the PAG level, featuring sections representing each PAG. Each section may display the percentage of components (e.g., Apps, DB, Host, MQ, URL) that are being actively monitored. For example, the “AIDT” section shows 76%, indicating that 76% of the components in the AIDT PAG are monitored, while the remaining 24% require attention.

Bottom Section 340 offers further insights into observability coverage for each PAG. This Section displays observability coverage percentages at the facet level. For example, within the AIDT PAG, the bar chart shows 67% coverage for Apps, 100% for DB, and 25% for URLs, signifying the percentage of each component type being monitored. Different colors or notations within the bars represent unique observability/monitoring tools, as shown by 330. Other graphics and representations may be implemented.

FIG. 4 is exemplary user interface providing a detailed view, according to an embodiment of the present invention. Interacting with any PAG widget in the top or bottom sections may navigate users to a detailed level dashboard specific to that PAG Observability coverage. This illustration provides extensive information, including filter options (e.g., ID, Sub-PAG, and Facet), facet-level observability coverage (at 410) displayed in bar chart format (at 420), and a detailed table widget with granular information (at 430). As shown by 430, monitoring details may include: identifier, facet, resource, tool name, monitoring status and comments.

An embodiment of the present invention may provide recommendations on how to address or remedy monitoring instances that need attention, correction and/or modification for optimization/improvement. The recommendations may be automatically generated and implemented in certain scenarios. The recommendations may also provide a strategy or plan to enable a technical team to efficiently and effectively address identified monitoring gaps and other issues. Other variations may be supported.

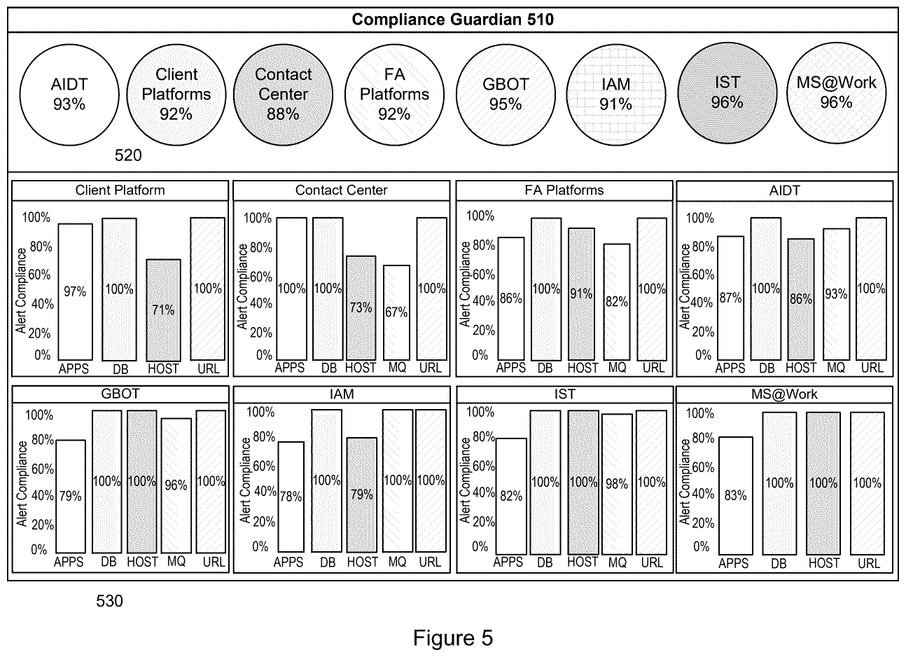

FIG. 5 is an exemplary compliance interface, according to an embodiment of the present invention. FIG. 5 illustrates a Compliance Guardian interface 510 that focuses on assessing the compliance of configured alerts with predefined standards.

Top Section 520 offers a PAG-level view, with each widget representing a PAG within a business unit. For example, the “AIDT” section may display 93%, indicating that 93% of the configured alerts within the AIDT department comply with Alert standards.

Bottom Section 530 may include bar charts or other graphics. This section further breaks down compliance percentages at the facet level for each PAG. This section may identify specific areas that may require attention. For example, within the AIDT PAG, the bar chart show 97% compliance for Apps and 71% for Hosts, indicating areas where compliance may be lacking.

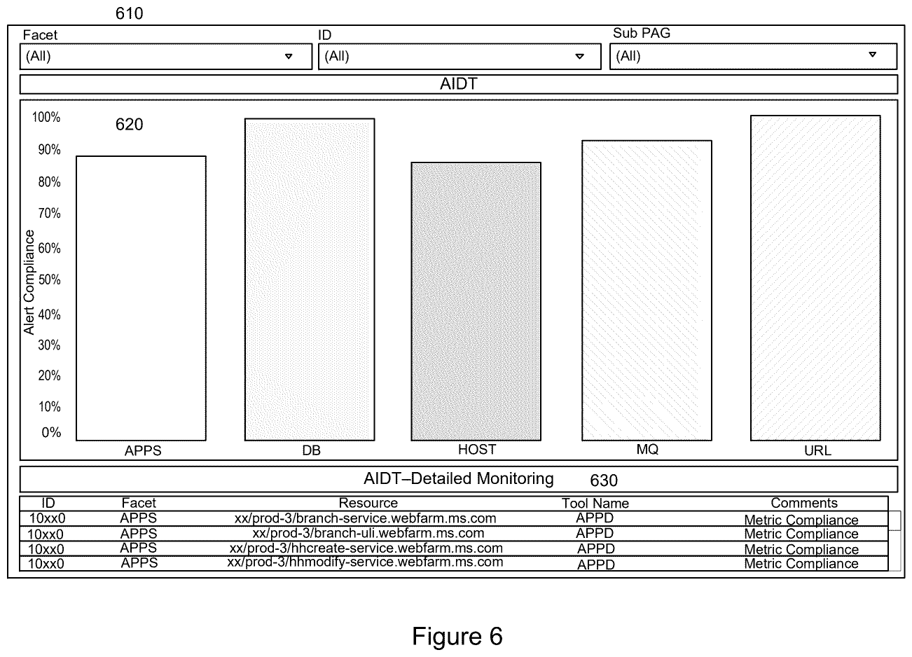

FIG. 6 is exemplary user interface providing a detailed view, according to an embodiment of the present invention. Interacting with a department in the top section 610 may direct users to a detailed level interface specific to the department's alert compliance. This detailed view may include filter options, facet-level compliance displayed in a bar chart (or other graphic) at 620, and a detailed table 630 with comprehensive data, including ID, Facet name, Resource name, Tool Name, monitored status, and comments from ASG.

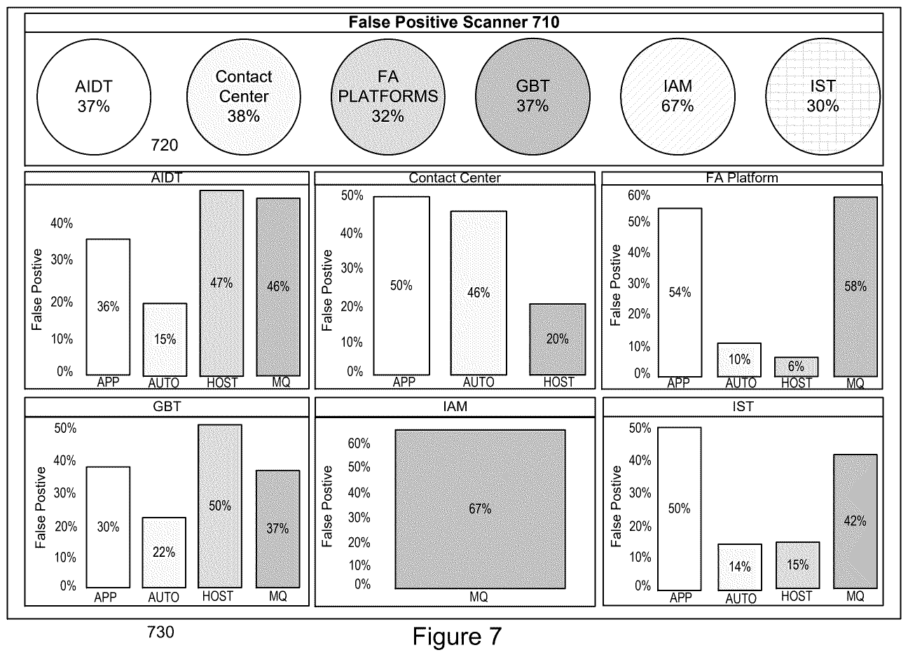

FIG. 7 is an exemplary user interface, according to an embodiment of the present invention. False Positive Scanner 710 may include Section 720 that provides high level false positive indicators across a business unit and Section 730 with detailed false positive graphics for each PAG.

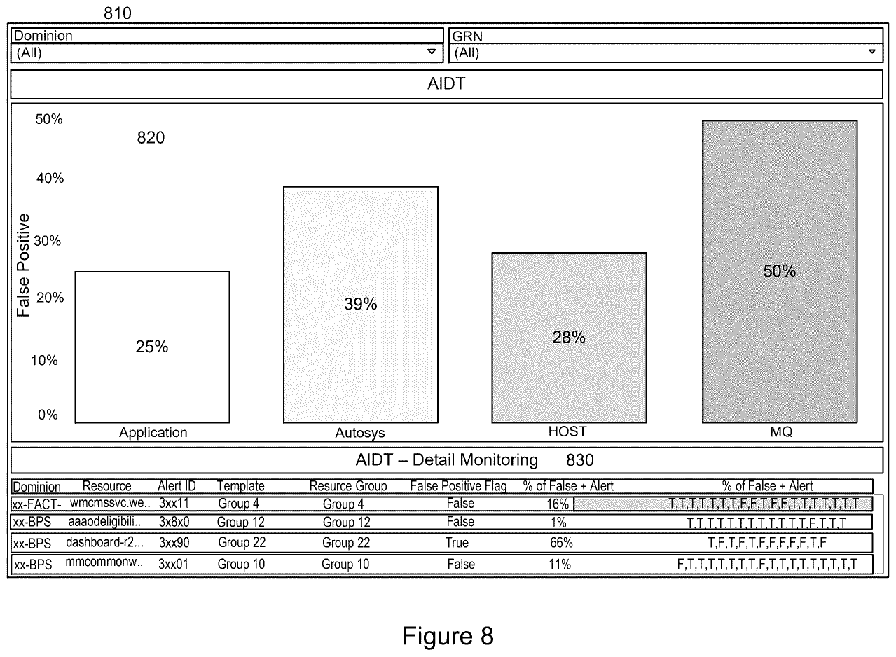

FIG. 8 is an exemplary user interface, according to an embodiment of the present invention. The Detailed Level of False Alarm Identifier interface provides a granular view of false positive alerts and aims to empower application support engineers to analyze and address these issues effectively. As shown in FIG. 8, False Positive Scanner may include multiple sections.

Filter Options 810 provides filter options including Dominion and Global Resource Name (GRN), allowing users to refine data based on their needs.

Middle Section (Bar Chart Widget) 820 may display the percentage of false positive alerts at the facet level based on the selected filters. For example, this section may show 75% for Apps, indicating that 75% of the alerts for Apps have been flagged as false positives.

Bottom Section (Detailed Table Widget) 830 may present a comprehensive table with granular information, including ID, Facet name, Resource name, Tool Name, monitored status (Y/N), and comments from ASG. The table may assist users identify specific components generating false positive alerts and assess their performance.

As shown in FIG. 8, a False Positive Flag section that indicates whether an alert configuration is red-flagged for false positives, based on the configured threshold (e.g., 60%).

Percentage of False Positive Alerts section may display the percentage of false positive alerts within the selected time duration. For instance, if an alert triggered 100 times in a month, with 75 being false positives, this column will show 75%.

Performance of Alert Column may provide a binary assessment of alert performance (True or False) for each alert occurrence within the selected time duration.

The user interfaces of FIGS. 2-7 may interface and communicate with various users via a communication network. Other users and integrations may be supported.

The system components are exemplary and illustrative, an embodiment of the present invention may interact with additional modules, a combination of the modules described and/or less modules than illustrated. While a single illustrative block, module or component is shown, these illustrative blocks, modules or components may be multiplied for various applications or different application environments. In addition, the modules or components may be further combined into a consolidated unit. The modules and/or components may be further duplicated, combined and/or separated across multiple systems at local and/or remote locations. Other architectures may be realized.

The illustrated system may be communicatively coupled to various Data Stores as well as remote storages. Data stores may also store and maintain source code, reports, performance data, historical data, etc. These storage components may include any suitable data structure to maintain the information and allow access and retrieval of the information. The storage may be local, remote, or a combination. The storage components may have back-up capability built-in. Communications with the storage components may be over a network or communications may involve a direct connection between the various storage components. The storage components may also represent cloud or other network based storage.

The system may be implemented in a variety of ways. Architecture within the system may be implemented as hardware components (e.g., module) within one or more network elements. It should also be appreciated that architecture within the system may be implemented in computer executable software (e.g., on a tangible, non-transitory computer-readable medium) located within one or more network elements. Module functionality of architecture within the system may be located on a single device or distributed across a plurality of devices including one or more centralized servers and one or more mobile units or end user devices. The architecture depicted in the system is meant to be exemplary and non-limiting. For example, while connections and relationships between the elements of system are depicted, it should be appreciated that other connections and relationships are possible. The system described may be used to implement the various methods herein, by way of example. Various elements of the system may be referenced in explaining the exemplary methods described herein.

Networks may be a wireless network, a wired network or any combination of wireless network and wired network. Networks may further include one, or any number of the exemplary types of networks operating as a stand-alone network or in cooperation with each other. Networks may utilize one or more protocols of one or more network elements to which it is communicatively coupled. Networks may translate to or from other protocols to one or more protocols of network devices. Although Networks may be depicted as one network for simplicity, it should be appreciated that according to one or more embodiments, Networks may comprise a plurality of interconnected networks, such as, for example, a service provider network, the Internet, a cellular network, corporate networks, or even home networks, or any of the types of networks mentioned above.

Data may be transmitted and received via Networks utilizing a standard networking protocol or a standard telecommunications protocol. For example, data may be transmitted using protocols and systems suitable for transmitting and receiving data. Data may be transmitted and received wirelessly or in some cases may utilize cabled network or telecom connections or other wired network connection.

While the figures illustrate individual devices or components, it should be appreciated that there may be several of such devices to carry out the various exemplary embodiments. The system may communicate using any mobile or computing device, such as a laptop computer, a personal digital assistant, a smartphone, a smartwatch, smart glasses, other wearables or other computing devices capable of sending or receiving network signals. Computing devices may have an application installed that is associated with the illustrated system.

Those skilled in the art will appreciate that the diagrams discussed above are merely examples of a system and a method for applying natural language processing to generate SQL queries on a custom enterprise data warehouse using Gen AI and are not intended to be limiting. Other types and configurations of networks, servers, databases and personal computing devices (e.g., desktop computers, tablet computers, mobile computing devices, smart phones, etc.) may be used with exemplary embodiments of the invention.

Although the foregoing examples show the various embodiments of the invention in one physical configuration, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. The components of the various embodiments may be arranged at any location or locations within a distributed network without affecting the operation of the respective system.

Although examples of servers, databases, and personal computing devices have been described above, exemplary embodiments of the invention may utilize other types of devices whereby a user may interact with a network that transmits and delivers data and information used by the various systems and methods described herein. These devices may further include an electronic memory such as a random access memory (RAM), electronically programmable read only memory (EPROM), other computer chip-based memory, a hard drive, or other magnetic, electrical, optical or other media, and other associated components connected over an electronic bus, as will be appreciated by persons skilled in the art.

In some embodiments, the computing devices may be equipped with an integral or connectable liquid crystal display (LCD), electroluminescent display, a light emitting diode (LED), organic light emitting diode (OLED) or another display screen, panel or device for viewing and manipulating files, data and other resources, for instance using a graphical user interface (GUI) or a command line interface (CLI). The personal computing devices may also include a network-enabled appliance or another TCP/IP client or other device.

The servers, databases, and personal computing devices described above may include at least one accelerated processing unit, such as a GPU or FPGA, and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software. The modules described above may comprise software stored in the memory (e.g., non-transitory computer readable medium containing program code instructions executed by the processor) for executing the methods described herein.

Any suitable programming language may be used in accordance with the various embodiments of the invention. For example, the programming language used may include assembly language, Ada, APL, Basic, C, C++, dBase, Forth, HTML, Android, iOS, .NET, Python, Java, Modula-2, Pascal, Prolog, REXX, Visual Basic, and/or JavaScript. Further, it is not necessary that a single type of instructions or single programming language be utilized in conjunction with the operation of the system and method of the invention. Rather, any number of different programming languages may be utilized as is necessary or desirable.

The software, hardware and services described herein may be provided utilizing one or more cloud service models, such as Software-as-a-Service (SaaS), Platform-as-a-Service (PaaS), Infrastructure-as-a-Service (IaaS), and Logging as a Service (LaaS), and/or using one or more deployment models such as public cloud, private cloud, hybrid cloud, and/or community cloud models.

In the system and method of exemplary embodiments of the invention, a variety of “user interfaces” may be utilized to allow a user to interface with the personal computing devices. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor.

Although the embodiments of the invention have been described herein in the context of a particular implementation in a particular environment for a particular purpose, those skilled in the art will recognize that its usefulness is not limited thereto and that the embodiments of the invention can be beneficially implemented in other related environments for similar purposes.

The foregoing description, along with its associated embodiments, has been presented for purposes of illustration only. It is not exhaustive and does not limit the invention to the precise form disclosed. Those skilled in the art may appreciate from the foregoing description that modifications and variations are possible in light of the above teachings or may be acquired from practicing the disclosed embodiments. For example, the steps described need not be performed in the same sequence discussed or with the same degree of separation. Likewise various steps may be omitted, repeated, or combined, as necessary, to achieve the same or similar objectives. Accordingly, the invention is not limited to the above-described embodiments, but instead is defined by the appended claims in light of their full scope of equivalents. The specification and drawings are accordingly to be regarded as an illustrative rather than restrictive sense.

1. A computer-implemented monitoring system comprising:
a computer server comprising one or more processors;
a centralized database storing monitoring data; and
non-transitory memory comprising instructions that, when executed by the one or more processors, cause the one or more processors to:
extract, via a monitoring tool data extractor, monitoring data from a plurality of disparate monitoring tools deployed within an entity;
extract, via a database extractor, configuration data from a plurality of disparate configuration management databases residing within the entity;
extract, via an alert data extractor, alert data from a plurality of disparate aggregation tools deployed within the entity;
normalize, via a normalization engine, the extracted monitoring data, the extracted configuration data and the extracted alert data into a common data format, wherein the monitoring tool data extractor, the database extractor and the alert data extractor are communicatively coupled to the normalization engine that translates a plurality of extracted data from disparate sources into the common data format;
store, via the centralized database, normalized extracted data in the common data format, wherein the centralized database is communicatively coupled to a monitoring standards repository and a metadata repository to enable a systematic comparison using the common data format to determine resource level compliance;
analyze, via a monitoring gap analyzer, the normalized extracted data to identify one or more monitoring gaps within the plurality of disparate monitoring tools;
analyze, via a monitoring standard analyzer, the normalized extracted data to identify one or more instances of non-compliance based on a set of monitoring standards and the extracted configuration data;
analyze, via a false positive alert identifier, the normalized extracted data to identify one or more false positive alerts associated with the plurality of disparate monitoring tools based on the extracted alert data, wherein the one or more false positive alerts are determined with respect to a predetermined threshold;
generate, via the processor, a monitoring coverage metric that represents the one or more monitoring gaps, an alert-compliance metric that represents one or more instances of non-compliance and a false positive metric that represents the one or more false positive alerts, wherein the monitoring coverage metric, the alert-compliance metric and the false positive metric represents a comprehensive IT landscape associated with the entity, wherein the monitoring gap analyzer, the monitoring standard analyzer and the false positive alert analyzer operate in an interrelated simultaneous manner to generate multiple layers of analysis to the comprehensive IT landscape;
transmit, via a communication network, the monitoring coverage metric, the alert-compliance metric and the false positive metric to an interactive user interface; and
executing, via the processor, an automatic adjustment to the predetermined threshold to bring one or more components into compliance with the set of monitoring standards based on the false positive metric.

2. The computer-implemented system of claim 1, wherein the interactive user interface comprises a corresponding monitoring coverage metric, a corresponding alert-compliance metric and a corresponding false positive metric for a plurality of business units within the entity.

3. The computer-implemented system of claim 1, wherein the interactive user interface comprises an observability interface that provides coverage metrics for each monitoring tool from the plurality of disparate monitoring tools wherein the coverage metrics represent a coverage percentage for each facet of components.

4. The computer-implemented system of claim 3, wherein the observability interface provides the coverage metrics for a specific monitoring tool at a component level.

5. The computer-implemented system of claim 1, wherein the interactive user interface comprises a compliance interface that provides compliance metrics for each monitoring tool from the plurality of disparate monitoring tools wherein the compliance metrics represent a compliance percentage for each facet of components.

6. The computer-implemented system of claim 5, wherein the compliance interface provides the compliance metrics for a specific monitoring tool at a component level.

7. The computer-implemented system of claim 1, wherein the interactive user interface comprises a false positive interface that provides false positive metrics for each monitoring tool from the plurality of disparate monitoring tools wherein the false positive metrics represent a percentage of false positives above the predetermined threshold.

8. The computer-implemented system of claim 7, wherein the false positive interface provides the false positive metrics for a specific monitoring tool at a component level.

9. The computer-implemented system of claim 1, wherein the false positive analyzer removes at least one of: duplicative alerts, related alerts or symptomatic alerts.

10. (canceled)

11. A computer-implemented monitoring method comprising the steps of:
extracting, via a monitoring tool data extractor, monitoring data from a plurality of disparate monitoring tools deployed within an entity;
extracting, via a database extractor, configuration data from a plurality of disparate configuration management databases residing within the entity;
extracting, via an alert data extractor, alert data from a plurality of disparate aggregation tools deployed within the entity;
normalizing, via a normalization engine, the extracted monitoring data, the extracted configuration data and the extracted alert data into a common data format, wherein the monitoring tool data extractor, the database extractor and the alert data extractor are communicatively coupled to the normalization engine that translates a plurality of extracted data from disparate sources into the common data format;
storing, via the centralized database, normalized extracted data in the common data format, wherein the centralized database is communicatively coupled to a monitoring standards repository and a metadata repository to enable a systematic comparison using the common data format to determine resource level compliance;
analyzing, via a monitoring gap analyzer, the normalized extracted data to identify one or more monitoring gaps within the plurality of disparate monitoring tools;
analyzing, via a monitoring standard analyzer, the normalized extracted data to identify one or more instances of non-compliance based on a set of monitoring standards and the extracted configuration data;
analyzing, via a false positive alert identifier, the normalized extracted data to identify one or more false positive alerts associated with the plurality of disparate monitoring tools based on the extracted alert data, wherein the one or more false positive alerts are determined with respect to a predetermined threshold;
generating, via the processor, a monitoring coverage metric that represents the one or more monitoring gaps, an alert-compliance metric that represents one or more instances of non-compliance and a false positive metric that represents the one or more false positive alerts, wherein the monitoring coverage metric, the alert-compliance metric and the false positive metric represents a comprehensive IT landscape associated with the entity, wherein the monitoring gap analyzer, the monitoring standard analyzer and the false positive alert analyzer operate in an interrelated simultaneous manner to generate multiple layers of analysis to the comprehensive IT landscape;
transmitting, via a communication network, the monitoring coverage metric, the alert-compliance metric and the false positive metric to an interactive user interface; and
executing, via the processor, an automatic adjustment to the predetermined threshold to bring one or more components into compliance with the set of monitoring standards based on the false positive metric.

12. The computer-implemented method of claim 11, wherein the interactive user interface comprises a corresponding monitoring coverage metric, a corresponding alert-compliance metric and a corresponding false positive metric for a plurality of business units within the entity.

13. The computer-implemented method of claim 11, wherein the interactive user interface comprises an observability interface that provides coverage metrics for each monitoring tool from the plurality of disparate monitoring tools wherein the coverage metrics represent a coverage percentage for each facet of components.

14. The computer-implemented method of claim 13, wherein the observability interface provides the coverage metrics for a specific monitoring tool at a component level.

15. The computer-implemented method of claim 11, wherein the interactive user interface comprises a compliance interface that provides compliance metrics for each monitoring tool from the plurality of disparate monitoring tools wherein the compliance metrics represent a compliance percentage for each facet of components.

16. The computer-implemented method of claim 15, wherein the compliance interface provides the compliance metrics for a specific monitoring tool at a component level.

17. The computer-implemented method of claim 11, wherein the interactive user interface comprises a false positive interface that provides false positive metrics for each monitoring tool from the plurality of disparate monitoring tools wherein the false positive metrics represent a percentage of false positives above the predetermined threshold.

18. The computer-implemented method of claim 17, wherein the false positive interface provides the false positive metrics for a specific monitoring tool at a component level.

19. The computer-implemented method of claim 11, wherein the false positive analyzer removes at least one of: duplicative alerts, related alerts or symptomatic alerts.

20. (canceled)
